(19) United States
(12) Patent Application Publication
(10) Pub. No.: US 2015/0182072 A1
(43) Pub. Date: Jul. 2, 2015

(54) Cooking Vessel

(71) Applicant: Jeff Steininger, St. Mary's, OH (US)

(72) Inventor: Jeff Steininger, St. Mary's, OH (US)

(73) Assignee: ZAK DESIGNS, INC., Spokane, WA (US)

(21) Appl. No.: 14/141,253

(22) Filed: Dec. 26, 2013

(51) Int. Cl. A47J 37/06; A47J 37/10

(52) U.S. Cl. CPC A47J 37/0694; A47J 37/108

(57) ABSTRACT

A cooking vessel is described and which includes a floor having a multiplicity of spaced upwardly extending ribs for supporting a food product during a cooking process, a circumscribing side wall which defines, at least in part a fluid collecting channel, and a pouring spout made integral with the circumscribing sidewall and which allows for the convenient removal of fluids which have been utilized during or which have been generated as a result of a cooking process.

### TECHNICAL FIELD

The present invention relates to a cooking vessel, and more specifically to a cooking vessel which permits the preparation of a wide number of food products in a manner not possible heretofore, and which further is effective in draining away fluids of various types which may be generated as a part of the cooking process and collecting these same fluids for ease of disposal.

### BACKGROUND OF THE INVENTION

Cooking vessels of various types have been known for multiple millenniums. People who have prepared foods over long periods of time know that certain foods, such as pork, beef and assorted poultry including chicken, turkey and duck, for example, produce liberal amounts of juices which may include various fats and other substances which are contained within these food products.

In some instances the juices of these food products are collected for assorted purposes including making gravy, or further are collected for additional basting as is often the case when preparing turkey, and some other poultry dishes. In preparing assorted pork products, such as bacon and the like, liberal amounts of juice including various fat compounds are produced. Many consumers of pork products desire to drain away this excess fluid including many of the fat components because such fluids have constituent elements which are unhealthy if consumed in large quantities. In some instances, in preparing various pork related products such as bacon and the like, users in the past have attempted to drain away the liquid, fat containing components, by assorted different means including having it absorbed or blotted by an underlying paper towel, or elevated on screens and allowed to drip onto an underlying plate. While these attempts to remove this fat containing fluid have worked with some degree of success, the fat containing liquid coming from products such as bacon and the like, once cooled, is often difficult to remove from plates, and the like, so users have looked for other ways to efficiently drain away this fat containing liquid component without the use of further blotters, and other methodology which has been used heretofore.

The prior art is replete with various attempts to provide cooking vessels which provide a means for positioning a pork product, such as bacon, in an elevated location above an underlying cooking surface so that fat containing components may drain downwardly under the influence of gravy. This orientation of the food product further allows the cooked product to be easily removed, and not rest in immediate contact with the fat containing component which has been generated by the cooking process. All these attempts have worked with some degree of success. However the rapid and convenient disposal of this cooking liquid which often contains various fatty based components, remains problematic.

A cooking vessel which avoids the detriments associated with the assorted cooking vessels which have been utilized heretofore, for similar purposes, is the subject matter of the present application.

### SUMMARY OF THE INVENTION

A first aspect of the present invention relates to a cooking vessel which includes a floor which has a sloped, upwardly facing surface, and a peripheral edge which defines, at least in part, a fluid collecting channel, and wherein the floor further defines a multiplicity of spaced, upwardly extending ribs for supporting a food product to be cooked, and which are further made integral with the sloped upwardly facing surface of the floor; and a circumscribing wall which is made integral with the peripheral edge of the floor and which further extends upwardly therefrom to a given height, and wherein the circumscribing wall defines, at least in part, a portion of the fluid collecting channel, and wherein the circumscribing wall further has a passageway formed therein, and which passes therethrough, and which further communicates with the fluid collecting channel.

Still another aspect of the present invention relates to a cooking vessel which includes a floor which has a uniformly sloped, and non-horizontally disposed, upwardly facing surface, and wherein the floor is discontinuous, and defines, at least in part, a multiplicity of spaced, and substantially parallel fluid draining channels which have a predetermined length dimension, and wherein the floor has a peripheral edge which defines, at least in part, a fluid collecting channel; a multiplicity of spaced, upwardly extending ribs, each having an apex, and which are further made integral with the floor, and wherein each of the upwardly extending ribs have a base which is made integral with the floor and which defines, at least in part, a portion of the adjacent fluid draining channel, and wherein each of the upwardly extending ribs has an overall elongated shape, and further has opposite ends, and wherein the opposite ends of the respective spaced, upwardly extending ribs are disposed in spaced relation relative to the adjacent fluid collecting channel, and wherein the apex of each of the upwardly extending ribs lies along a predetermined, substantially horizontal plane which has a given height dimension; a circumscribing wall which is made integral with the peripheral edge of the floor, and which forms, at least in part, a portion of the fluid collecting channel, and wherein the circumscribing wall further extends upwardly to a given height dimension which is greater than the height dimension of the horizontal plane as defined by each apex of the respective upwardly extending ribs, and wherein a passageway is formed in the circumscribing wall, at a given location, and which further communicates with the fluid collecting channel; and a pouring spout mounted on the circumscribing wall, and extending outwardly therefrom, and which communicates with the passageway formed in the circumscribing wall.

These and other aspects of the present invention will be discussed in greater detail hereinafter.

### BRIEF DESCRIPTION OF THE DRAWINGS

Preferred embodiments of the invention are described below with reference to the following accompanying drawings:

FIG. 1 is a perspective, top plan view of the cooking vessel of the present invention.

FIG. 2 is a transverse, vertical sectional view taken from a position along line 2-2 of FIG. 1.

FIG. 3 is a perspective, bottom view of the cooking vessel of the present invention.

FIG. 4 is a side elevation view of a pair of cooking vessels shown in a nesting, stored configuration.

### DETAILED DESCRIPTION OF THE PREFERRED EMBODIMENT

This disclosure of the invention is submitted in furtherance of the constitutional purposes of the U.S. Patent laws “to promote the progress of science and useful arts.” (Article I, Section 8).

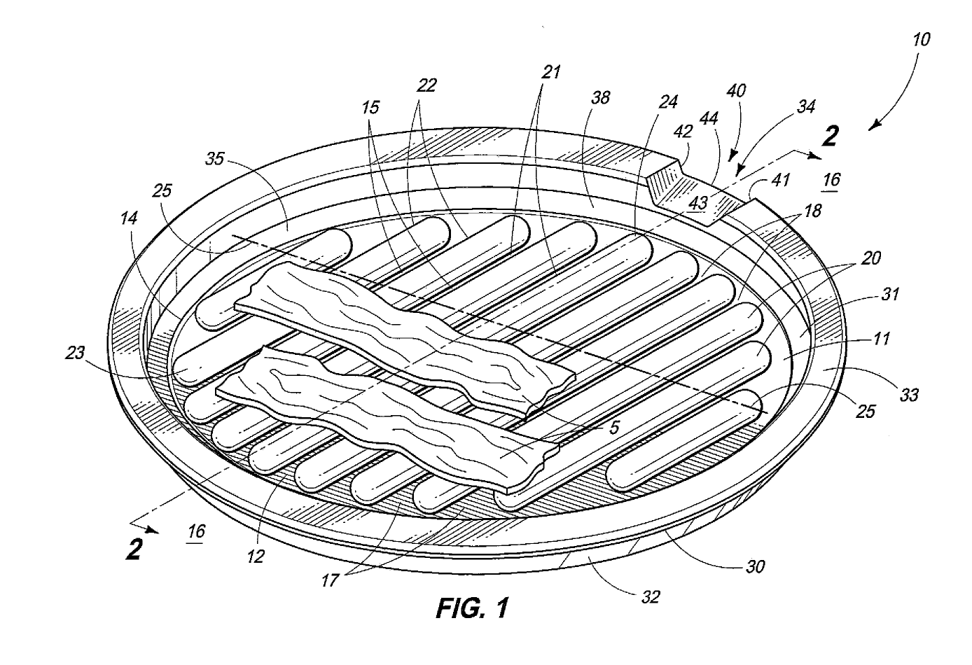

A cooking vessel of the present invention is generally indicated by the numeral 10 in FIG. 1 and following. As will be appreciated from studying the drawings the present cooking vessel 10 is useful when utilized in the preparation of various food products, and where the presence or absence of various fluids may have an overall effect on the resulting quality of the food product which has been prepared. In some cases, as earlier discussed, the food product being prepared generates, during the cooking process, copious amounts of fluid which may include various fat components which many users wish to drain away from the accompanying product as it is being prepared. As seen in FIG. 1, bacon strips 5 are seen in a supported portion within the cooking vessel 20. In other instances, such as when a user desires to steam vegetables, and the like, a user of the present cooking vessel will add water, and other substances in an amount such that the resulting steam generated from this water can prepare the vegetables to an appropriate cooked state. Moreover, various food products which are prepared often come in a frozen form, and defrosting the frozen food product typically generates a fair amount of water which, again, must be drained away from the previously frozen food product so that the food product can be prepared in an appropriate fashion. Finally, when a consumer reheats leftover foods from previous meals, it is often found desirable that the leftovers be treated in a way such that air can circulate around the food product which is being reheated so as to prevent the food product from becoming overly soggy or soaked with water that may have been generated as a result of the earlier cooking process. The present cooking vessel is able to be utilized for all of these functions and others, and further is easy to clean, and provides a convenient means by which any resulting fluids which are generated either from the cooking process, or which are initially provided to implement the cooking process (such as water or cooking oils) may be conveniently disposed of once the cooking process is completed.

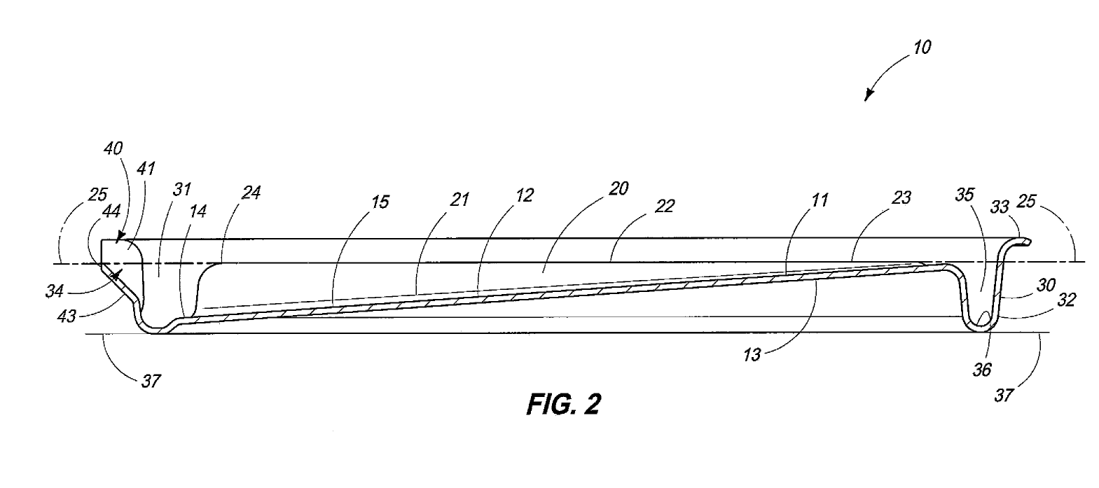

The cooking vessel 10 of the present invention is defined at least in part, by a floor which is generally indicated by the numeral 11. The floor is substantially discontinuous, and is furhter uniformly sloped as seen in FIG. 2. The non-horizontally disposed floor 11 has an upwardly facing surface 12, and an opposite, downwardly facing surface 13. The floor further is defined by a peripheral edge 14. The discontinuous, uniformly slopped and non-horizontally disposed upwardly facing surface 11 defines a plurality of fluid draining channels 15 as best seen in FIG. 1. As illustrated in the drawings, the floor 11, in particular, is illustrated as being substantially circular in shape. However, various other shapes may be utilized such as an oval, squares, and the like, without departing from the teachings of the present invention.

The cooking vessel 10 of the present invention includes a multiplicity of spaced, upwardly extending ribs 20, and which are made integral with the floor 11. The spaced multiplicity of upwardly extending ribs each have a base 21 which is made integral with the sloping floor 11, and which further defines, at least in part, a portion of the adjacent fluid draining channels 15. Further, each of the multiplicity of spaced upwardly extending ribs 20 defines an apex or crest 22. Each of the upwardly extending ribs has an overall elongated shape, and has opposite first and second ends 23 and 24, and wherein the upwardly extending ribs 20 are further disposed in spaced relation relative to a circumscribing wall as will be discussed in greater detail, below. As will be seen by reference to FIGS. 1 and 2, the apex 22 of each of the upwardly extending and spaced ribs 20 lies along a predetermined substantially horizontal plane 25 which has a given height dimension when measured from an underlying supporting surface upon which the cooking vessel 10 rests.

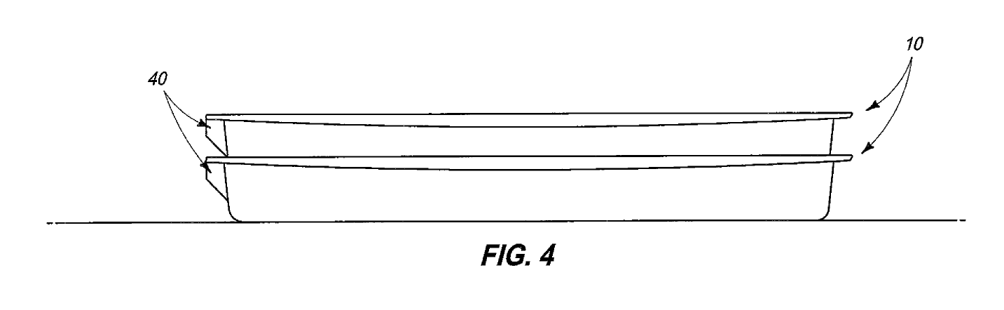

The cooking vessel 10 of the present invention further includes a circumscribing wall 30 which is made integral with the peripheral edge 14 of the floor 11. The circumscribing wall 30 further has an inside facing surface 31, and an outside facing surface 32. Still further the circumscribing wall 30 has a top peripheral edge 33. Additionally, as will be seen in the drawings, a passageway 34 having given dimensions is formed in, and passes through, the circumscribing wall 30. The passageway 34, and its function will be discussed in greater detail, below. As will be recognized from a study of the drawings, the circumscribing wall 30, in combination with the floor 11, and the peripheral edge of the floor 14, defines a circumscribing fluid collecting channel 35 which is substantially continuous. The fluid collecting channel 35 has a uniform width dimension when measured between the floor 11, and the circumscribing wall 30, and a non-uniform depth dimension. As seen in FIG. 2, the passageway 34 which is formed in the circumscribing wall 30 is located adjacent to a region of the fluid collecting channel 35 which has the shallowest depth dimension 38. Additionally, and as will be seen in FIG. 2, the fluid collecting channel 35 has a continuous, lowermost trough region 36 which lies along a predetermined, substantially horizontal plane 37. As will be recognized by a study of FIG. 2, the second end 24 of each of the fluid draining channels 15 are disposed in closely adjacent relation relative to the region of the fluid collecting channel 35 which has the shallowest depth dimension 38. As will be recognized by study of FIG. 2, the respective upwardly facing ribs 20 have a height dimension, when measured from the floor 11 which lies in a range of about 5 mm to about 17 mm, and a length dimension which lies in a range of about 60 mm to about 190 mm. As will additionally be recognized by a study of FIG. 4, the circumscribing wall 30 of the cooking vessel 10 is shaped so as to facilitate the partial, telescoping nesting of one cooking vessel 10 within another cooking vessel 10 when they are oriented in a stored configuration. The top peripheral edge 33 of the circumscribing wall has a given height dimension as will be seen in FIG. 2 and which is measured from an underlying supporting surface upon which the cooking vessel 10, rests. The height dimension of the circumscribing wall 30 is greater than the height dimension of the horizontal plane 25 which is defined by each apex or crest of each of the respective multiplicity of spaced, upwardly extending ribs 20. Generally speaking, the multiplicity of upwardly extending ribs 20 and more specifically the apex or crest 22 thereof, is parabolic when viewed in cross section. Further, each of the spaced upwardly extending ribs 20 has a similar width dimension when this dimension is measured at the base 21 of each of the respective ribs 20. The respective plurality of fluid draining channels 15 are generally linear in shape, and have a substantially similar width dimension.

The cooking vessel 10 of the present invention further includes a pouring spout which is generally indicated by the numeral 40. In this regard, the pouring spout 40 is defined by a first and second sidewalls 41 and 42 respectively which are made integral with the outside facing surface 32 of the circumscribing wall 30 of the cooking vessel 10. The respective first and second sidewalls 41 and 42 extend normally outwardly relative to the outside facing surface 32 of the circumscribing wall 30. As will be appreciated, the passageway 34 is further defined by an inclined bottom wall 43 which extends between the respective sidewalls 41 and 42, and which further extends outwardly relative to the circumscribing wall 30 of the cooking vessel 10 to define the pouring spout 40 which communicates with the passage way 34. The pouring spout 40 provides a convenient means whereby fluid which collects within the fluid collecting channel 35 may be easily drained away in a manner not possible, heretofore. The pouring spout 40, and more specifically the inclined bottom wall 43 has a distal end 44. As we recognize by study of FIG. 2, the horizontal plane 25 as defined by the respective apex or crests 22 of each of the spaced upwardly extending ribs 20 is located at a given height dimension, and the inclined outwardly extending bottom wall of the pouring spout which has the distal end 44 is located at a height dimension which is about equal to that of the height dimension of the horizontal plane 25.

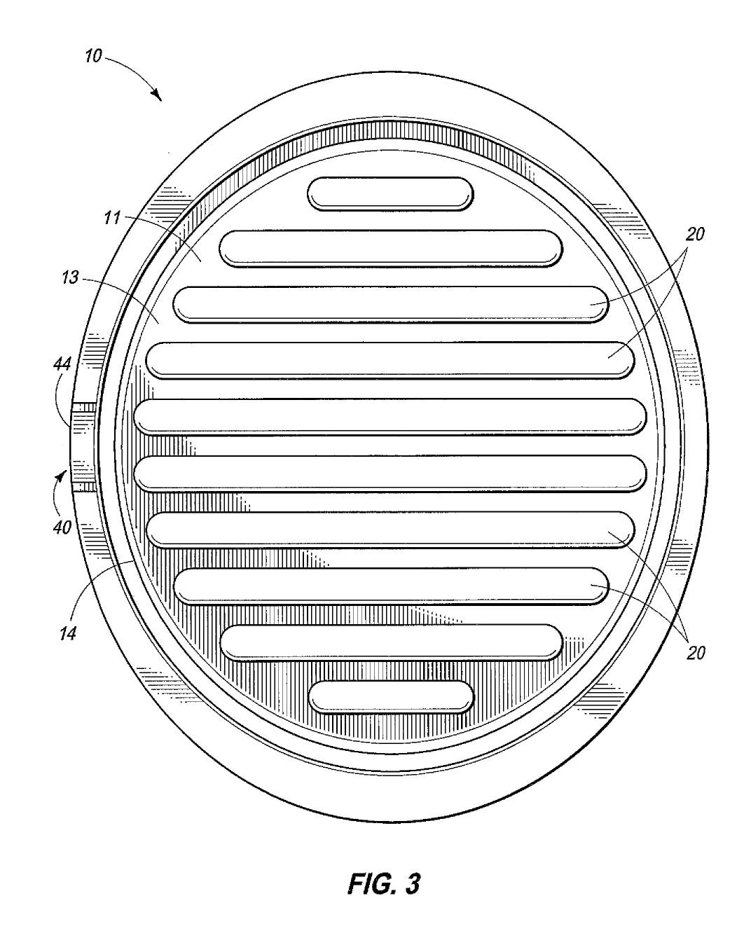

In the arrangement as seen in the drawings it will be recognized that the cooking vessel 10 is fabricated from a moldable substrate, and further has a downwardly facing surface 13 as seen in FIG. 3. Because of the molding process, the downwardly facing surface 13 of the cooking vessel 10 has a shape which is largely a reverse mirror image of the shape of the upwardly facing surface 12 as seen in the drawings.

### Operation

The operation of the described embodiment of the present invention is believed to be readily apparent, and is briefly summarized at this point.

In its broadest aspect, the present invention relates to a cooking vessel 10 which includes a floor 11 which has a sloped, upwardly facing surface 12, and a peripheral edge 14 which defines, at least in part, a fluid collecting channel 35. The floor 11 further defines a multiplicity of spaced, upwardly extending ribs 20 for supporting a food product to be cooked, and which are further made integral with the sloped upwardly facing surface of the floor 11. The cooking vessel further includes a circumscribing wall 30 which is made integral with the peripheral edge 14 of the floor 11, and which further extends upwardly therefrom to a given height. The circumscribing wall 30 further has a passageway 34 which is formed therein, and which passes therethrough, and which further communicates with the fluid collecting channel 35. In the arrangement as seen in the drawings, the sloped upwardly facing surface of the floor 11 is uniformly sloped at an angle of about 2° to about 6° from the horizontal. Additionally as will be recognized in FIG. 2, the respective upwardly extending ribs 20 each have an upper-most apex or crest 22. The respective apexes 22 each lie along a predetermined plane which is substantially horizontal 25.

As will be recognized in the drawings, the respective upwardly extending ribs 20, each have opposite ends 23 and 24 respectively. The opposite ends 23 and 24 of each of the upwardly extending ribs 20 are disposed in spaced relation relative to the circumscribing wall 30. Additionally as will be seen in the drawings, the respective upwardly extending ribs 20 each have a base 21 which is made integral with the floor 11, and are further linearly elongated, and have varying length dimensions. The respective ribs 20 each have a substantially uniform width dimension when measured at the base 21. As will be recognized in FIG. 1, the cooking vessel 10 of the present invention has opposite sides 16, and in the arrangement as shown, the individual fluid draining channels 15 are respectively defined between adjacent upwardly extending ribs 20, and further extend in the direction of the opposite sides of the cooking vessel 16. The fluid draining channels 15 have an overall linear shape, a uniform width dimension when measured at the base 21 of each of the upwardly extending ribs 20, and a variable length dimension. Each of the fluid draining channels 15 has a first and an opposite second end 17 and 18 respectively, and wherein the second end 18 is located elevationally lower than the first end. Still further, and as seen in the drawings, the passageway 34 is formed on the side 16 of the cooking vessel 10 where the second end 18 of each of the fluid draining channels 15 terminate and near the shallowest region 38 of the fluid collection channel 35.

As earlier disclosed, the cooking vessel 10 includes a circumscribing wall 30 which extends upwardly to a vertical height which is greater than the height of the horizontal plane 25, and which is defined by the respective apex 22 of each of the spaced upwardly extending ribs 20.

Therefore it will be seen that the present invention provides a cooking vessel which allows a consumer to prepare various food products in a manner not possible heretofore. The present cooking vessel is easy to use, convenient to clean, and further provides a means whereby fluids generated as a result of the cooking process, or fluids which have been added so as to facilitate the cooking of the food products, like water, and the like, may be disposed of in a manner which has not been possible heretofore.

In compliance with the statute, the invention has been described in a language more or less specific as to structural and methodical features. It is to be understood, however, that the invention is not limited to the specific features shown and described since the means herein disclosed comprise preferred forms of putting the invention into effect. The invention is, therefore, claimed in any of its forms or modifications within the proper scope of the appended claims appropriately interpreted in accordance with the Doctrine of Equivalents.

I claim:

1. A cooking vessel, comprising:
a floor which has a sloped, upwardly facing surface, and a peripheral edge which defines, at least in part, a fluid collecting channel, and wherein the floor further defines a multiplicity of spaced, upwardly extending ribs for supporting a food product to be cooked, and which are further made integral with the sloped upwardly facing surface of the floor; and
a circumscribing wall which is made integral with the peripheral edge of the floor and which further extends upwardly therefrom to a given height, and wherein the circumscribing wall defines, at least in part, a portion of the fluid collecting channel, and wherein the circumscribing wall further has a passageway formed therein, and which passes therethrough, and which further communicates with the fluid collecting channel.

2. A cooking vessel as claimed in claim 1, and wherein the sloped, upwardly facing surface of the floor is uniformly sloped at an angle of about 2° to about 6° from the horizontal plane.

3. A cooking vessel as claimed in claim 2, and wherein the respective, upwardly extending ribs each have an uppermost apex, and wherein the apex of each of the upwardly extending ribs lies along a predetermined plane which is substantially horizontal.

4. A cooking vessel as claimed in claim 1, and wherein the respective, upwardly extending ribs each have opposite ends, and wherein the opposite ends of each of the upwardly extending ribs are disposed in spaced relation relative to the circumscribing wall.

5. A cooking vessel as claimed in claim 1, and wherein the respective, upwardly extending ribs each have a base which is made integral with the floor, and are further linearly elongated, and have varying length dimensions, and wherein the respective ribs each have a substantially uniform width dimension when measured at the base.

6. A cooking vessel as claimed in claim 5, and wherein the cooking vessel has opposite sides, and wherein individual fluid draining channels are respectively defined between the adjacent, upwardly extending ribs, and further extend in the direction of the opposite sides of the cooking vessel, and wherein the fluid draining channels have an overall linear shape, a uniform width dimension when measured at the base of each of the upwardly extending ribs, and a variable length dimension, and wherein each of the channels has a first end, and an opposite second end, and wherein the second end is located elevationally lower than the first end, and wherein the passageway formed in the circumscribing wall of the cooking vessel is formed on the side of the cooking vessel where the first end of each of the fluid draining channels terminate.

7. A cooking vessel as claimed in claim 3, and wherein the circumscribing wall extends upwardly to a vertical height which is greater than a height of the horizontal plane which is defined by the respective apex of each of the spaced, upwardly extending ribs.

8. A cooking vessel as claimed in claim 3, and wherein the passageway formed in the circumscribing wall of the cooking vessel is defined, at least in part, by a pair of spaced sidewalls which are made integral with the circumscribing wall of the cooking vessel, and which further extend normally outwardly relative thereto, and wherein the passageway is further defined by an inclined bottom wall which extends between the respective sidewalls, and which further extends outwardly relative to the circumscribing wall of the cooking vessel, and wherein the respective outwardly extending sidewalls and the inclined, outwardly extending bottom wall define a pouring spout for the cooking vessel.

9. A cooking vessel as claimed in claim 8, and wherein the circumscribing wall of the cooking vessel is shaped in a fashion such that a pair of cooking vessels can partially, telescopingly nest, one within another, in a stored configuration.

10. A cooking vessel as claimed in claim 9, and wherein the horizontal plane as defined by the apex of each of the spaced, upwardly extending ribs is located at a given height dimension, and wherein the inclined outwardly extending bottom wall of the pouring spout has a distal end which is located at a height dimension which is about equal to the height dimension of the horizontal plane.

11. A cooking vessel, comprising:
a floor which has a uniformly sloped, and non-horizontally disposed, upwardly facing surface, and wherein the floor is discontinuous, and defines, at least in part, a multiplicity of spaced, and substantially parallel fluid draining channels which have a predetermined length dimension, and wherein the floor has a peripheral edge which defines, at least in part, a fluid collecting channel;
a multiplicity of spaced, upwardly extending ribs, each having an apex, and which are further made integral with the floor, and wherein each of the upwardly extending ribs have a base which is made integral with the floor and which defines, at least in part, a portion of the adjacent fluid draining channel, and wherein each of the upwardly extending ribs has an overall elongated shape, and further has opposite ends, and wherein the opposite ends of the respective spaced, upwardly extending ribs are disposed in spaced relation relative to the adjacent fluid collecting channel, and wherein the apex of each of the upwardly extending ribs lies along a predetermined, substantially horizontal plane which has a given height dimension;
a circumscribing wall which is made integral with the peripheral edge of the floor, and which forms, at least in part, a portion of the fluid collecting channel, and wherein the circumscribing wall further extends upwardly to a given height dimension which is greater than the height dimension of the horizontal plane as defined by each apex of the respective upwardly extending ribs, and wherein a passageway is formed in the circumscribing wall, at a given location, and which further communicates with the fluid collecting channel; and
a pouring spout mounted on the circumscribing wall, and extending outwardly therefrom, and which communicates with the passageway formed in the circumscribing wall.

12. A cooking vessel as claimed in claim 11, and wherein the apex of each of the ribs have a parabolic shape, and wherein the base of each of the spaced, upwardly extending ribs has a similar width dimension, and wherein each of the ribs has a variable length dimension.

13. A cooking vessel as claimed in claim 12, and wherein the respective fluid draining channels each have an overall linear shape, a uniform width dimension, when the width dimension is measured at the base of each of the adjacent upwardly extending ribs, and a variable length dimension, and wherein each fluid draining channel has an opposite, first and a second end, and wherein the first end of the fluid draining channel is located elevationally above the second end of the fluid draining channel.

14. A cooking vessel as claimed in claim 13, and wherein the pouring spout is defined, at least in part, by a bottom wall which extends outwardly relative to the circumscribing wall, and which further has a distal end which is located at a height dimension which is similar to that of the horizontal plane.

15. A cooking vessel as claimed in claim 14, and wherein the circumscribing wall of the cooking vessel is shaped so as to facilitate the partial, telescoping nesting of one cooking vessel within another cooking vessel when oriented in a stored configuration.

16. A cooking vessel as claimed in claim 15, and wherein the fluid collecting channel has a uniform width dimension when measured between the floor, and the circumscribing wall, and a non-uniform depth dimension, and wherein the passageway formed in the circumscribing wall is located adjacent to a region of the fluid collecting channel which has the shallowest depth dimension.

17. A cooking vessel as claimed in claim 16, and wherein the second end of each of the fluid draining channels are disposed in closely adjacent relation relative to the region of the fluid collecting channel which has the shallowest depth dimension.

18. A cooking vessel as claimed in claim 17, and wherein the fluid collecting channel has a continuous lowermost trough region, and wherein the lowermost trough region lies along a predetermined substantially horizontal plane.

19. A cooking vessel as claimed in claim 18, and wherein the respective upwardly facing ribs have a height dimension, when measured from the floor which lies in a range of about 5 mm to about 17 mm and a length dimension which lies in a range of about 60 mm to about 190 mm.

20. A cooking vessel as claimed in claim 19, and wherein the cooking vessel is fabricated from a moldable substrate, and further has an opposite, downwardly facing surface, and wherein the downwardly facing surface of the cooking vessel has a shape which is a reverse mirror image of a shape of the upwardly facing surface.
